(19) United States
(12) Patent Application Publication
(10) Pub. No.: US 2025/0042748 A1
(43) Pub. Date: Feb. 6, 2025

(54) METHOD OF PREPARING SILICON COMPOSITE OXIDE FOR ANODE ACTIVE MATERIAL, ANODE FOR SECONDARY BATTERY AND LITHIUM SECONDARY BATTERY INCLUDING THE SAME

(71) Applicant: SK ON CO., LTD., Seoul (KR)

(72) Inventors: Ji Hee BAE, Daejeon (KR); Hyeon Soo KANG, Daejeon (KR); Jae Ram KIM, Daejeon (KR); Ji Won NA, Daejeon (KR); So Hyun PARK, Daejeon (KR); Sang Won BAE, Daejeon (KR); Yeon Hwa SONG, Daejeon (KR); Ki Joo EOM, Daejeon (KR); Jeong Seok YEON, Daejeon (KR); Myung Ro LEE, Daejeon (KR); Jae Yeong LEE, Daejeon (KR); Hyun Joong JANG, Daejeon (KR)

(21) Appl. No.: 18/774,926

(22) Filed: Jul. 17, 2024

(30) Foreign Application Priority Data
Jul. 31, 2023 (KR) 10-2023-0100069

(51) Int. Cl. C01B 33/113; H01M 4/02; H01M 4/131; H01M 10/052

(52) U.S. Cl. CPC C01B 33/113; H01M 4/131; H01M 10/052; C01P 2002/72; C01P 2004/84; C01P 2006/12; C01P 2006/40; C01P 2006/80; H01M 2004/027

(57) ABSTRACT

An anode for a secondary battery includes an anode current collector, a first anode active material layer disposed on at least one surface of the anode current collector and including a first anode active material that includes a first silicon composite oxide, and a second anode active material layer disposed on the first anode active material layer and including a second anode active material that includes a second silicon composite oxide. Each of the first silicon composite oxide and the second silicon composite oxide includes a metal. A BET specific surface area of each of the first silicon composite oxide and the second silicon composite oxide is in a range from 2.0 m²/g to 6.5 m²/g.

### CROSS-REFERENCE TO RELATED APPLICATION AND CLAIM OF PRIORITY

This application claims priority to Korean Patent Application No. 10-2023-0100069 filed on Jul. 31, 2023 in the Korean Intellectual Property Office (KIPO), the entire disclosure of which is incorporated by reference herein.

### BACKGROUND

### 1. Field

The present disclosure relates to a method of preparing a silicon composite oxide for an anode active material, an anode for a secondary battery and a lithium secondary battery including the same.

### 2. Description of the Related Art

A secondary battery which can be charged and discharged repeatedly has been widely employed as a power source of a mobile electronic device such as a camcorder, a mobile phone, a laptop computer, etc., according to developments of information and display technologies. Recently, a battery pack including the secondary battery is being developed and applied as a power source of an eco-friendly vehicle such as an electric automobile, a hybrid vehicle, etc.

Examples of the secondary battery includes a lithium secondary battery, a nickel-cadmium battery, a nickel-hydrogen battery, etc. The lithium secondary battery is being actively developed and applied due to high operational voltage and energy density per unit weight, a high charging rate, a compact dimension, etc.

For example, the secondary battery may include an electrode assembly including a cathode, an anode and a separation layer (separator), and an electrolyte impregnating the electrode assembly. The secondary battery may further include an exterior material in the form of, e.g., a pouch that accommodates the electrode assembly and the electrolyte.

A carbon-based active material and a silicon-based active material may be used as an anode active material included in the anode. The silicon-based active material can provide high capacity. However, when charging/discharging is repeated, mechanical and chemical damages such as particle cracks may easily occur in the silicon-based active material.

### SUMMARY

According to an aspect of the present disclosure, there is provided an anode for a lithium secondary battery having improved power properties and initial efficiency.

According to an aspect of the present disclosure, there is provided a lithium secondary battery including the anode for a secondary battery and having improved power properties and initial efficiency.

According to an aspect of the present disclosure, there is provided a method of preparing a silicon composite oxide included in the anode for a secondary battery.

An anode for a secondary battery includes an anode current collector, a first anode active material layer disposed on at least one surface of the anode current collector and including a first anode active material that includes a first silicon composite oxide, and a second anode active material layer disposed on the first anode active material layer and including a second anode active material that includes a second silicon composite oxide. Each of the first silicon composite oxide and the second silicon composite oxide includes a metal, and a BET specific surface area of each of the first silicon composite oxide and the second silicon composite oxide is in a range from 2.0 m²/g to 6.5 m²/g.

In some embodiments, the metal may include magnesium.

In some embodiments, each of the first silicon composite oxide and the second silicon composite oxide may include SiOx (0<x<2) doped with magnesium and a carbon coating layer formed on a surface thereof.

In some embodiments, each of the first silicon composite oxide and the second silicon composite oxide may include 5.0 wt % to 10.0 wt % of magnesium.

In some embodiments, a sum of weights of the first silicon composite oxide and the second silicon composite oxide may be 10 wt % to 20 wt % of a total weight of the first anode active material layer and the second anode active material layer.

In some embodiments, a weight-based content of the first silicon composite oxide included in the first anode active material layer is less than a weight-based content of the second silicon composite oxide included in the second anode active material layer.

In some embodiments, the content of the first silicon composite oxide may be in a range from 2 wt % to 10 wt % based on a total weight of the first anode active material layer.

In some embodiments, the content of the second silicon composite oxide is in a range from 18 wt % to 30 wt % based on a total weight of the second anode active material layer.

In some embodiments, each crystallite size in a (220) plane defined by Equation 1 of the first silicon composite oxide and the second silicon composite oxide may be in a range from 3.5 nm to 10 nm.

$${L}_{220} = \frac{K λ}{{β}_{220} cos θ} \qquad [ Equation 1 ]$$

In Equation 1, L₂₂₀ represents the crystallite size (nm) in the (220) plane, K represents a shape factor, λ represents an X-ray wavelength (nm), β₂₂₀ represents a full width at half maximum (rad) of a peak of the (220) plane through an XRD analysis, and θ represents a diffraction angle (rad)

In some embodiments, the BET specific surface area of each of the first silicon composite oxide and the second silicon composite oxide may be in a range from 2.5 m²/g to 6.0 m²/g.

A lithium secondary battery includes the above-described anode for a secondary battery, and a cathode facing the anode.

In a method of preparing a silicon composite oxide for an anode active material, a mixed gas of silicon (Si), silicon dioxide (SiO₂) and a metal is reacted to form a preliminary silicon composite oxide. A carbon coating layer is formed on a surface of the preliminary silicon composite oxide using a carbon source that has a thermal decomposition temperature of 500° C. to 700° C.

In some embodiments, the metal may include magnesium.

In some embodiments, the carbon source may include at least one of ethylene and acetylene.

An anode for a secondary battery according to embodiments of the present disclosure provides a high electrical conductivity, and a lithium secondary battery including the anode have an improved charging capacity. An anode active material layer of the cathode above may be formed in a multi-layered structure, and a charging capacity of the lithium secondary battery may be increased while improving a stability of the battery.

According to a method of preparing a silicon composite oxide for an anode active material according to embodiments of the present disclosure, carbon may be uniformly coated on a surface of the silicon composite oxide. Accordingly, a curvature of the surface of the silicon composite oxide may be reduced, and thus a stability of the anode including the silicon composite oxide may be improved.

The anode and the lithium secondary battery of the present disclosure may be widely applied in green technology fields such as an electric vehicle, a battery charging station, a solar power generation, a wind power generation, etc., using a battery. The anode and the lithium secondary battery according to the present disclosure may be used for eco-friendly electric vehicles and hybrid vehicles to prevent a climate change by suppressing air pollution and greenhouse gas emission.

### BRIEF DESCRIPTION OF THE DRAWINGS

FIGS. 1 and 2 are schematic cross-sectional views illustrating an anode for a secondary battery in accordance with example embodiments.

FIGS. 3 and 4 are a schematic plan view and a schematic cross-sectional view, respectively, illustrating a lithium secondary battery in accordance with example embodiments.

FIG. 5 is a schematic flowchart for describing a method of preparing a silicon composite oxide for an anode active material in accordance with example embodiments.

### DETAILED DESCRIPTION OF THE EMBODIMENTS

Hereinafter, embodiments of the present disclosure will be described in detail with reference to accompanying drawing and examples. However, those skilled in the art will appreciate that such embodiments are provided to further understand the spirit of the present inventive concepts do not limit the subject matters to be protected as disclosed in the detailed description and appended claims.

The terms “bottom surface,” “top surface”, etc., used herein are used in a relative sense to distinguish positions of components and do not specify absolute positions.

### <Anode for Secondary Battery>

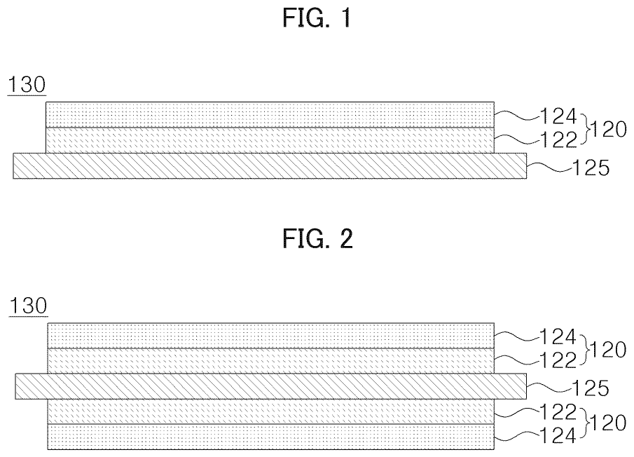

FIGS. 1 and 2 are schematic cross-sectional views illustrating an anode for a secondary battery in accordance with example embodiments.

Referring to FIG. 1, an anode 130 may include an anode active material layer 120 disposed on at least one surface of an anode current collector 125.

In example embodiments, the anode active material layer 120 may have a multi-layered structure including a first anode active material layer 122 and a second anode active material layer 124.

The anode current collector 125 may include, e.g., a copper foil, a nickel foil, a stainless steel foil, a titanium foil, a nickel foam, a copper foam, or a polymer substrate coated with a conductive metal.

The anode active material layer 120 may be coated on at least one of top and bottom surfaces of the anode current collector 125. The anode active material layer 120 may directly contact the surface of the anode current collector 125.

In example embodiments, the first anode active material layer 122 may be formed directly on the surface of the anode current collector 125. The second anode active material layer 124 may be formed directly on a surface of the first anode active material layer 122.

The first anode active material layer 122 may include a first anode active material including a first silicon composite oxide. The second anode active material layer 124 may include a second anode active material including a second silicon composite oxide.

The term “silicon composite oxide” used herein may refer to a compound or a material in which an element other than silicon and oxygen are mixed or integrated into a silicon oxide.

In example embodiments, the first silicon composite oxide and the second silicon composite oxide may each include a metal. For example, the metal may include magnesium (Mg), aluminum (Al), zinc (Zn), bismuth (Bi), cadmium (Cd), lead (Pb), zirconium (Zr), tin (Sn), gallium (Ga), indium (In), yttrium (Y), cesium (Cs), niobium (Nb), etc. Accordingly, an initial capacity efficiency of a secondary battery containing the silicon composite oxide may be improved.

In some embodiments, the first silicon composite oxide and the second silicon composite oxide may each include a carbon coating layer on a surface thereof. For example, the carbon coating layer may be coated using at least one of ethylene and acetylene as a carbon source. Accordingly, a life-span stability of the silicon composite oxide may be improved.

A silicon oxide may react with a relatively large number of Li ions. Therefore, the silicon oxide may be used as the anode active material, so that a capacity of the secondary battery may be improved. However, when the silicon oxide reacts with the Li ions, a volume expansion of the anode active material may be increased, and life-span characteristics and stability of the anode may be deteriorated. Additionally, the silicon oxide may have a relatively low electrical conductivity.

However, according to embodiments of the present disclosure, a metal-containing silicon composite oxide may be used as the anode active material. Accordingly, the electrical conductivity of the silicon composite oxide and the anode containing the silicon composite oxide may be improved. Additionally, the carbon coating layer may be formed on the silicon composite oxide. Thus, the life-span stability of the silicon composite oxide may be improved.

In some embodiments, the metal may include magnesium, and the electrical conductivity of the silicon composite oxide may be further improved.

In some embodiments, a content of the metal (e.g., magnesium) contained in each of the first silicon composite oxide and the second silicon composite oxide based on each total weight of the first silicon composite oxide and the second silicon composite oxide may be in a range from 5.0 weight percent (wt %) to 10.0 wt %, from 7.0 wt % to 9.0 wt %, from 7.0 wt % to 8.0 wt %, or from 7.7 wt % to 8.0 wt %. In the above metal (e.g., magnesium) content range, the electrical conductivity of the silicon composite oxide may be improved by the metal (e.g., magnesium) while suppressing a decrease in the life-span characteristics of the silicon composite oxide. Thus, the initial capacity efficiency may be improved.

In some embodiments, the carbon coating layer may be formed on the surface of each of the first silicon composite oxide and the second silicon composite oxide, and magnesium may be doped in each of the first silicon composite oxide and the second silicon composite oxide. For example, the first silicon composite oxide and the second silicon composite oxide may each include SiOx (0<x<2).

In an embodiment, the first silicon composite oxide and the second silicon composite oxide may each include magnesium-doped SiOx (0<x<2). Additionally, the carbon coating layer may be formed on the surface of the magnesium-doped SiOx (0<x<2).

Accordingly, an energy density may be improved by the silicon oxide (e.g., SiOx (0<x<2)) and the electrical conductivity may be enhanced by magnesium doped into the silicon oxide. Thus, the initial capacity efficiency and long-term life-span characteristics of the first silicon composite oxide and the second silicon composite oxide may be improved.

In example embodiments, the first silicon composite oxide may be used as a first anode active material together with a material capable of adsorbing and desorbing lithium ions. The second silicon composite oxide may be used as a second anode active material together with a material capable of adsorbing and desorbing adsorb and desorb lithium ions.

Materials capable of adsorbing and desorbing lithium ions include, e.g., a carbon-based material such as a crystalline carbon, an amorphous carbon, a carbon composite, a carbon fiber, etc.; a lithium metal; a lithium alloy; a silicon (Si)-containing material or a tin (Sn)-containing material, etc.

Examples of the amorphous carbon include hard carbon, soft carbon, coke, a mesocarbon microbeads (MCMB), a mesophase pitch-based carbon fiber (MPCF), etc.

Examples of the crystalline carbon include a graphite-based carbon such as a natural graphite, an artificial graphite, a graphitized coke, a graphitized MCMB, a graphitized MPCF, etc.

The lithium metal may refer to a metal layer containing lithium. A protective layer may be formed on the lithium metal to inhibit a dendrite growth. In an embodiment, a lithium metal-containing layer deposited or coated on the anode current collector may be used as the anode active material layer. In an embodiment, a lithium thin-film or a lithium foil may be used as the anode active material layer.

Elements included in the lithium alloy include aluminum, zinc, bismuth, cadmium, antimony, silicon, lead, tin, gallium, indium, etc.

The silicon-containing active material may include Si or a silicon-carbon composite.

In some embodiments, a sum of weights of the first silicon composite oxide and the second silicon composite oxide may be in a range from 10 wt % to 20 wt % based on a total weight of the first anode active material layer 122 and the second anode active material layer 124. In the above weight range, the charging capacity of the secondary battery may be improved. In an embodiment, the sum of the weight of the first silicon composite oxide and the second silicon composite oxide may be in a range from 11 wt % to 17 wt %, from 12 wt % to 17 wt %, or from 12 wt % to 15 wt % based on the total weight of the first anode active material layer 122 and the second anode active material layer 124. In the above weight range, the charging capacity and stability of the secondary battery may both be improved.

In some embodiments, a weight-based content of the first silicon composite oxide included in the first anode active material layer 122 may be smaller than a weight-based content of the second silicon composite oxide included in the second anode active material layer 124. Accordingly, an average content of the silicon composite oxide included in the anode active material layer 120 may be reduced, and a content of the silicon composite oxide in contact with an electrolyte may be increased. Thu, the stability and charging capacity of the anode 130 may be improved.

In some embodiments, a content of the first silicon composite oxide may be in a range from 2 wt % to 10 wt % based on a total weight of the first anode active material layer 122. In the above range, the content of the first silicon composite oxide included in the first anode active material layer 122 may be reduced, thereby reducing the average content of the silicon composite oxide included in the anode active material layer 120.

Accordingly, a stability with respect to a volume expansion of the anode active material layer 120 may be improved. For example, the content of the first silicon composite oxide may be in a range from 3 wt % to 8 wt %, from 4 wt % to 8 wt %, or from 4 wt % to 6 wt % based on the total weight of the first cathode active material layer 122. In the above content range, the stability with respect to volume expansion of the anode active material layer 120 may be further improved.

In some examples, a content of the second silicon composite oxide may be in a range from 18 wt % to 30 wt % based on a total weight of the second cathode active material layer 124. In the above range, an energy density of the anode may be increased by increasing the content of the second silicon composite oxide in a direct contact with the electrolyte included in the second cathode active material layer 124.

Accordingly, the charging capacity of the secondary battery may be improved. In an embodiment, the content of the second silicon composite oxide may be in a range from 19 wt % to 26 wt %, from 20 wt % to 26 wt %, or from 20 wt % to 24 wt % based on the total weight of the second cathode active material layer 124. In the above range, the charging capacity of the lithium secondary battery may be further improved.

In some embodiments, a crystallite size in a (220) plane defined by the following Equation 1 of each of the first silicon composite oxide above and the second silicon composite oxide above may be in a range from 3.5 nm to 10.0 nm. In the above crystallite size range, aggregation and side reactions between the silicon composite oxides due to an excessively reduced size of the silicon composite oxide may be prevented so that the life-span characteristics of the anode may be improved. Further, volume instability due to an excessive increase in the crystallite size of the silicon composite oxide may be prevented, thereby improving the life-span characteristics.

In an embodiment, the crystallite size in the (220) plane defined by the following Equation 1 of each of the first silicon composite oxide above and the second silicon composite oxide may be in a range from 5.0 nm to 9.0 nm, from 5.0 nm to 7.0 nm, or from 6.0 nm to 7.0 nm. In the above crystallite size range, the life-span characteristics of the anode may be further improved.

$${L}_{220} = \frac{K λ}{{β}_{220} cos θ} \qquad [ Equation 1 ]$$

In Equation 1, L₂₂₀ represents the crystallite size (nm) in the (220) plane, K represents a shape factor, A represents an X-ray wavelength (nm), β₂₂₀ represents a full width at half maximum (rad) of a peak of the (220) plane through an XRD analysis, and θ represents a diffraction angle (rad). The shape coefficient (K) may be, e.g., 0.8 or 0.9.

In example embodiments, a BET specific surface area of each of the first silicon composite oxide and the second silicon composite oxide may be in a range from 2.0 m²/g to 6.5 m²/g. When the BET specific surface area of the first silicon composite oxide and the second silicon composite oxide is less than 2.0 m²/g, a reaction area may be reduced, and the initial capacity efficiency may be lowered. When the BET specific surface area of the first silicon composite oxide and the second silicon composite oxide exceeds 6.5 m²/g, the initial capacity efficiency may be reduced due to the side reaction with the electrolyte, etc. Accordingly, the BET specific surface area of the first silicon composite oxide and the second silicon composite oxide may be adjusted to the above range, thereby improving the initial efficiency of the secondary battery.

In some embodiments, the BET specific surface area of each of the first silicon composite oxide and the second silicon composite oxide may be in a range of 2.0 m²/g to 6.4 m²/g, or from 2.5 m²/g to 6.4 m²/g. In an embodiment, the BET specific surface area of the first silicon composite oxide and the second silicon composite oxide may be in a range from 2.5 m²/g to 6.0 m²/g, or in a range from 2.5 m²/g to 4.0 m²/g.

In the above specific surface area range, the side reactions may be suppressed while sufficiently increasing an area in which the silicon composite oxide contacts lithium. Accordingly, the initial efficiency of the secondary battery including the first silicon composite oxide and the second silicon composite oxide may be further improved.

The BET specific surface of the first silicon composite oxide and the second silicon composite oxide can be measured by a Brunauer-Emmett-Teller (BET) method.

In example embodiments, a first anode slurry may be prepared by dispersing the first cathode active material including the first silicon composite oxide described above in a solvent. The first anode slurry may further include a binder, and may optionally further include a conductive material, a thickener, etc.

In example embodiments, a second anode slurry may be prepared by dispersing the second cathode active material including the second silicon composite oxide described above in a solvent. The second anode slurry may further include a binder, and may optionally further include a conductive material, a thickener, etc.

In example embodiments, the first anode slurry and the second anode slurry may be coated on an anode current collector 125, and dried and pressed to form the first anode active material layer 122 and the second anode active material layer 124.

For example, after coating the first anode slurry on the anode current collector 125, the second anode slurry may be coated on the first anode slurry. For example, the first anode slurry and the second anode slurry may be coated together on the anode current collector 125. Thereafter, the first anode slurry coated on the anode current collector 125 and the second anode slurry coated on the first anode slurry may be dried together. Accordingly, the first anode active material layer 122 and the second anode active material layer 124 may be sequentially stacked on the anode current collector 125.

As described above, the first anode slurry and the second anode slurry may be coated together, and then dried simultaneously to substantially form the first anode active material layer 122 and the second anode active material layer 124 together.

In an embodiment, the first anode active material layer 122 and the second anode active material layer 124 may be individually formed. For example, the first anode slurry may be coated and dried on the anode current collector 125 to form the first anode active material layer 122, and then the second anode slurry may be coated and dried on the first anode active material layer 122 to form the second anode active material layer 124.

Non-limiting examples of the solvent for the first anode slurry and the second anode slurry may include water, pure water, deionized water, distilled water, ethanol, isopropanol, methanol, acetone, n-propanol, t-butanol, etc.

The binder may include a styrene-butadiene rubber (SBR)-based binder, carboxymethyl cellulose (CMC), a polyacrylic acid-based binder, a poly(3,4-ehtylenedioxythiophene) (PEDOT)-based binder, etc.

The conductive material may be added to improve a conductivity of the anode active material layer 120 and/or a mobility of lithium ions or electrons. For example, the conductive material may include a carbon-based conductive material such as graphite, carbon black, acetylene black, Ketjen black, graphene, a carbon nanotube, a VGCF (vapor-grown carbon fiber), a carbon fiber, etc., and/or a metal-based conductive material such as tin, tin oxide, a perovskite material such as titanium oxide, LaSrCoO₃, LaSrMnO₃, etc.

For example, carboxymethyl cellulose (CMC) may be used as the thickener.

Referring to FIG. 2, the anode active material layer 120 may include the first anode active material layer 122 formed directly on both surfaces of the anode current collector 125, and a second anode material layer 124 formed on the first anode active material layer 122. For example, the anode active material layer 120 of a double-layered structure including the first anode active material layer 122 and the second anode active material layer 124 sequentially stacked from the surface of the anode current collector 125 may be disposed on each of both surfaces of the anode current collector 125.

### <Lithium Secondary Battery>

According to embodiments of the present disclosure, a lithium secondary battery may include the above-described anode for a secondary battery.

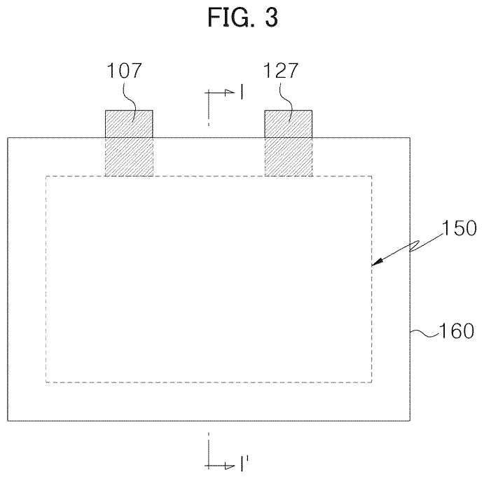

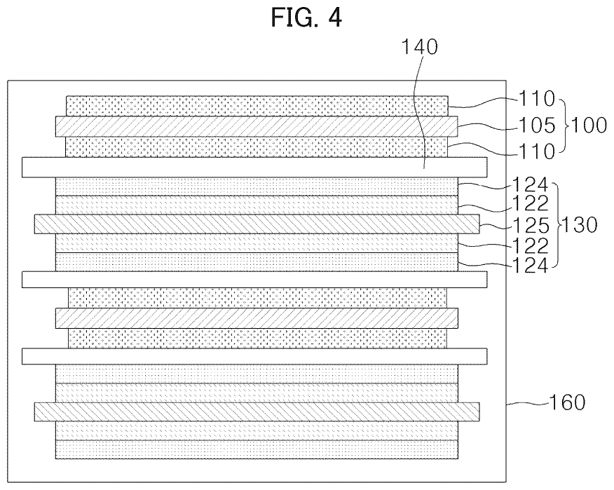

FIGS. 3 and 4 are a schematic plan view and a schematic cross-sectional view, respectively, illustrating a lithium secondary battery in accordance with example embodiments. For example, FIG. 4 is a cross-sectional view taken along a line I-I′ of FIG. 3 in a thickness direction. FIGS. 3 and 4 illustrate exemplary structures for the convenience of explanation, and the structure of the lithium secondary battery of the present disclosure is not limited to that shown in FIGS. 3 and 4.

Referring to FIGS. 3 and 4, the lithium secondary battery includes a cathode 100 and the anode 130, and may further include a separator 140 interposed between the cathode 100 and the anode 130. The cathode 100 may include a cathode active material layer 110 disposed on at least one surface of a cathode current collector 105.

The cathode current collector 105 may include stainless steel, nickel, aluminum, titanium, or an alloy thereof. The cathode current collector 105 may include aluminum or stainless steel surface-treated with carbon, nickel, titanium, silver, etc.

The cathode active material layer 110 may include a cathode active material. The cathode active material may include a compound capable of reversibly intercalating and de-intercalating lithium ions.

In example embodiments, the cathode active material may include a lithium-nickel metal oxide. The lithium-nickel metal oxide may further include at least one of cobalt (Co), manganese (Mn) and aluminum (Al).

In some embodiments, the cathode active material or the lithium-nickel metal oxide may include a layered structure or a crystal structure represented by Chemical Formula 1.

LiₓNiₐM_{b}O_{2+z} [Chemical Formula 1]

In Chemical Formula 1, 0.9≤x≤1.2, 0.5≤a≤0.99, 0.01≤b≤0.5, and −0.5≤z≤0.1.

As described above, M may include Co, Mn and/or Al.

The chemical structure represented by Chemical Formula 1 indicates a bonding relationship included in the layered structure or the crystal structure of the cathode active material, and is not intended to exclude another additional element. For example, M includes Co and/or Mn, and Co and/or Mn may serve as main active elements of the cathode active material together with Ni. Chemical Formula 1 is provided to express the bonding relationship of the main active elements, and is to be understood as a formula encompassing introduction and substitution of the additional element.

In an embodiment, an auxiliary element for enhancing chemical stability of the cathode active material or the layered structure/crystal structure may be further included in addition to the main active element. The auxiliary element may be incorporated into the layered structure/crystal structure to form a bond, and it is to be understood that this case is also included within the chemical structure represented by Chemical Formula 1.

The auxiliary element may include at least one of, e.g., Na, Mg, Ca, Y, Ti, Hf, V, Nb, Ta, Cr, Mo, W, Fe, Cu, Ag, Zn, B, Al, Ga, C, Si, Sn, Sr, Ba, Ra, P and Zr. The auxiliary element may act as an auxiliary active element such as Al which may contribute to capacity/power activity of the cathode active material together with Co or Mn.

For example, the cathode active material or the lithium-transition metal oxide particle may have a layered structure or a crystal structure represented by Chemical Formula 1-1 below.

LiₓNiₐM1_{b1}M2_{b2}O_{2+z} [Chemical Formula 1-1]

In Chemical Formula 1-1, M1 may include Co, Mn and/or Al. M2 may include the above-described auxiliary element. In Chemical Formula 1-1, 0.9≤x≤1.2, 0.5≤a≤0.99, 0.01≤b1+b2≤0.5, and −0.5≤z≤0.1.

The cathode active material may further include a coating element or a doping element. For example, an element substantially the same as or similar to the above-mentioned auxiliary element may be used as the coating element or the doping element. For example, one of the above elements or a combination of two or more therefrom may be used as the coating element or the doping element.

The coating element or the doping element may be present on a surface of the lithium-nickel metal oxide particle or may penetrate through the surface of the lithium-transition metal oxide particle to be included in the bonding structure represented by Chemical Formula 1 or Chemical Formula 1-1.

The cathode active material may include a nickel-cobalt-manganese (NCM)-based lithium oxide. In this case, an NCM-based lithium oxide having an increased nickel content may be used.

Ni may serve as a transition metal related to a power and a capacity of a lithium secondary battery. Therefore, as described above, a high-Ni composition may be employed for the cathode active material, so that a high-capacity cathode and a high-capacity lithium secondary battery may be implemented.

However, as the content of Ni increases, long-term storage stability and life-span stability of the cathode or the secondary battery may be relatively deteriorated, and side reactions with an electrolyte may be also increased. However, according to example embodiments, life-span stability and capacity retention may be improved by Mn while maintaining electrical conductivity by the inclusion of Co.

A Ni content (e.g., a mole fraction of nickel among total moles of nickel, cobalt and manganese) in the NCM-based lithium oxide may be 0.8 or more, 0.85 or more, 0.87 or more, or 0.90 or more. In some embodiments, the Ni content may be from 0.85 to 0.99, from 0.85 to 0.97, from 0.85 to 0.95, from 0.87 to 0.95, or from 0.90 to 0.95. In the Ni content range, capacity properties of the cathode and the lithium secondary battery may be improved.

For example, a cathode slurry may be prepared by dispersing the cathode active material in a solvent. The cathode slurry may be coated on the cathode current collector 105, and then dried and pressed to form the cathode 100. The cathode slurry may further include a binder and may optionally further include a conductive material, a thickener, etc.

Non-limiting examples of the solvent used to prepare the cathode slurry include N-methyl-2-pyrrolidone (NMP), dimethylformamide, dimethylacetamide, N,N-dimethylaminopropylamine, ethylene oxide, tetrahydrofuran, etc.

The binder may include polyvinylidene fluoride (PVDF), poly(vinylidene fluoride-co-hexafluoropropylene), polyacrylonitrile, polymethylmethacrylate, acrylonitrile butadiene rubber (NBR), polybutadiene rubber (BR), styrene-butadiene rubber (SBR), etc. In an embodiment, a PVDF-based binder may be used as the cathode binder.

The above-described materials that may be used in the formation of the anode may also be used as the conductive material and the thickener.

The anode 130 may include the above-described anode for a secondary battery.

In some embodiments, a separator 140 may be interposed between the cathode 100 and the anode 130. The separator may prevent an electrical short circuit between the anode 100 and the cathode 130 while maintaining a flow of ions.

For example, the separator 140 may include a porous polymer film or a porous non-woven fabric. The porous polymer film may include a polyolefin-based polymer such as an ethylene polymer, a propylene polymer, an ethylene/butene copolymer, an ethylene/hexene copolymer, an ethylene/methacrylate copolymer, etc. The porous non-woven fabric may include a high melting point glass fiber, a polyethylene terephthalate fiber, etc.

The separator 140 may include a ceramic-based material. For example, inorganic particles may be coated on the polymer film or dispersed in the polymer film to improve a heat resistance.

The separator 140 may have a single-layered or multi-layered structure including the polymer film and/or the non-woven fabric as described above.

In example embodiments, the cathode 100, the anode 130 and the separator 140 may be repeatedly disposed to form an electrode assembly 150. In some embodiments, the electrode assembly 150 may have a jelly roll shape formed by winding, stacking or zigzag folding (z-folding) of the separator 140.

In an embodiment, the electrode assembly 150 may have a jelly roll shape formed by winding the cathode 100, the anode 130 and the separator 140 together. In an embodiment, the electrode assembly 150 may have a jelly roll shape in which the notched cathodes 100 and anodes 130 are disposed in spaces formed by repeatedly z-folding the separator 140.

In an embodiment, the cathodes, the anodes and separator may be repeatedly stacked while being cut or separated at each layer to form the electrode assembly 150.

For example, electrode tabs (a cathode tab and an anode tab) may protrude from the cathode current collector 105 and the anode electrode current collector 125 to one side of a case 160. The electrode tabs may be welded together with the one side of the case 160 to form an electrode lead (a cathode lead 107 and an anode lead 127) extending or exposed to an outside of the case 160.

For example, a case having a pouch shape, a cylindrical shape, a prismatic shape or a coin shape may be used.

The electrode assembly 150 may be accommodated with an electrolyte solution in the case 160 to define a lithium secondary battery. In example embodiments, a non-aqueous electrolyte solution may be used as the electrolyte solution.

The non-aqueous electrolyte solution may include a lithium salt as an electrolyte and an organic solvent, and the lithium salt may be represented as, e.g., Li⁺X⁻. Examples of an anion X⁻ of the lithium salt include F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻, etc.

The organic solvent may include an organic compound that may have a sufficient solubility in the lithium salt and an additive and may not be reactive in the battery.

The organic solvent may include, e.g., at least one of a carbonate-based solvent, an ester-based solvent, an ether-based solvent, a ketone-based solvent, an alcohol-based solvent and an aprotic solvent. Examples of the organic solvent include propylene carbonate (PC), ethylene carbonate (EC), butylene carbonate, diethyl carbonate (DEC), dimethyl carbonate (DMC), ethyl methyl carbonate (EMC), methylpropyl carbonate, ethylpropyl carbonate, dipropyl carbonate, vinylene carbonate, methyl acetate (MA), ethyl acetate (EA), n-propyl acetate (n-PA), 1,1-dimethylethyl acetate (DMEA), methyl propionate (MP), ethylpropionate (EP), fluoroethyl acetate (FEA), difluoroethyl acetate (DFEA), trifluoroethyl acetate (TFEA), dibutyl ether, tetraethylene glycol dimethyl ether (TEGDME), diethylene glycol dimethyl ether (DEGDME), dimethoxyethane, tetrahydrofuran (THF), 2-methyltetrahydrofuran, ethyl alcohol, isopropyl alcohol, dimethyl sulfoxide, acetonitrile, diethoxy ethane, sulfolane, gamma-butyrolactone, propylene sulfite. These may be used alone or in combination of two or more therefrom.

The non-aqueous electrolyte solution may further include the additive. The additive may include, e.g., a cyclic carbonate-based compound, a fluorine-substituted carbonate-based compound, a sultone-based compound, a cyclic sulfate-based compound, a cyclic sulfite-based compound, a phosphate-based compound and a borate-based compound.

The cyclic carbonate-based compound may include vinylene carbonate (VC), vinyl ethylene carbonate (VEC), etc.

The fluorine-substituted cyclic carbonate-based compound may include fluoroethylene carbonate (FEC).

The sultone-based compounds include 1,3-propane sultone, 1,3-propene sultone, 1,4-butane sultone, etc.

The cyclic sulfate-based compound may include 1,2-ethylene sulfate, 1,2-propylene sulfate, etc.

The cyclic sulfite-based compound may include ethylene sulfite, butylene sulfite, etc.

The phosphate-based compound may include lithium difluoro bis-oxalato phosphate, lithium difluoro phosphate, etc.

The borate-based compound may include lithium bis(oxalato) borate.

### <Method of Preparing Silicon Composite Oxide for Anode Active Material>

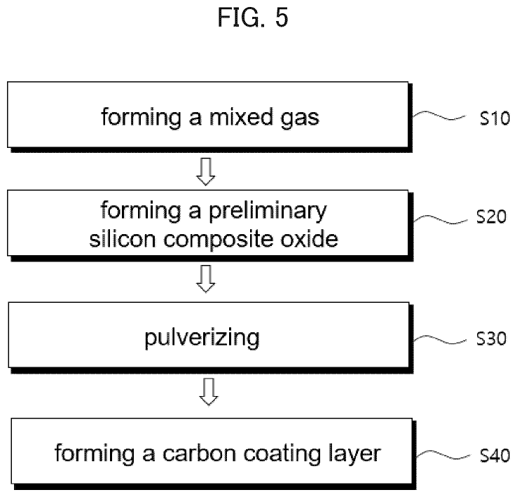

FIG. 5 is a schematic flowchart for describing a method of preparing a silicon composite oxide for an anode active material in accordance with example embodiments.

Referring to FIG. 5, a mixed gas containing silicon (Si), silicon dioxide (SiO₂) and a metal may be formed (e.g., in an operation S10).

For example, the metal may include magnesium (Mg), aluminum (Al), zinc (Zn), bismuth (Bi), cadmium (Cd), lead (Pb), zirconium (Zr), tin (Sn), gallium (Ga), indium (In), yttrium (Y), cesium (Cs), niobium (Nb), etc. Accordingly, the metal may be included in the silicon composite oxide, and thus an initial capacity efficiency may be improved.

In some embodiments, the metal may include magnesium. For example, the mixed gas may include silicon, silicon dioxide and magnesium. Accordingly, magnesium may be included in the silicon composite oxide, thereby preventing a phase transition of the silicon composite oxide at a high voltage and improving the initial capacity efficiency and long-term life-span characteristics.

In some embodiments, a content of the metal (e.g., magnesium) in the mixed gas may be in a range from 5.0 wt % to 10.0 wt %, from 7.0 wt % to 9.0 wt %, from 7.0 wt % to 8.0 wt %, or from 7.7 wt % to 8.0 wt %. The content of the metal included in the mixed gas may be substantially the same as a content of the metal included in each of the first silicon composite oxide and the second silicon composite oxide described above.

For example, the metal content of the first silicon composite oxide and the second silicon composite oxide may be determined depending on the content of the metal included in the mixed gas. Within the above range, deterioration of life-span characteristics of the silicon composite oxide may be suppressed, an electrical conductivity may be improved by the metal (e.g., magnesium), and the initial capacity efficiency may be improved.

In some embodiments, the mixed gas may be formed by independently vaporizing a silicon powder, a silicon dioxide powder and a magnesium powder. For example, the silicon powder, the silicon dioxide powder and the magnesium powder may be vaporized by being heated and evaporated in different independent reactors. The silicon powder, the silicon dioxide powder and the magnesium powder vaporized in independent reactors may be injected into one reactor and mixed with each other. Accordingly, the silicon powder, the silicon dioxide powder and the magnesium powder may each be independently vaporized to form the mixed gas.

In an embodiment, the silicon powder may be vaporized at a temperature in a range from 2,000° C. to 3,300° C., from 2,200° C. to 3,300° C., or from 2,300° C. to 3,300° C. In the temperature range, the silicon powder may be sufficiently vaporized.

In an embodiment, the silicon dioxide powder may be vaporized at a temperature in a range from 1,200° C. to 2,300° C., from 1,500° C. to 2,300° C., or from 1,800° C. to 2,300° C. In the temperature range, the silicon dioxide powder may be sufficiently vaporized.

In an embodiment, the magnesium powder may be vaporized at a temperature in a range from 1,000° C. to 1,200° C., from 1,050° C. to 1,200° C., or from 1,050° C. to 1,150° C. In the above temperature range, the magnesium powder may be sufficiently vaporized.

In example embodiments, a preliminary silicon composite oxide may be formed by reacting the mixed gas (e.g., in an operation S20).

In some embodiments, after reacting the mixed gas, the reacted mixed gas may be cooled. For example, the reacted mixed gas may be cooled using a cooling substrate. Examples of the cooling substrate include a cooling plate, a cooling fin, a cooling tube, etc. For example, the reacted mixed gas may be cooled to room temperature (e.g., 25° C.) by the substrate.

As the mixed gas is cooled, silicon clusters may be formed. A phase separation of a magnesium-silicon oxide complex formed from the silicon cluster according to Reaction Scheme 1 below may occur, and magnesium may be stably doped into silicon and a silicon oxide.

Si+SiO₂+Mg→Mg—SiOx(0<x<2) [Reaction Scheme 1]

In some embodiments, the reacted mixed gas may be cooled at a pressure from 5 Pa to 100 Pa, from 5 Pa to 80 Pa, from 5 Pa to 50 Pa, or from 10 Pa to 50 Pa. In the above pressure range, magnesium may be doped between the silicon oxides without causing side reactions between a gaseous silicon, a gaseous silicon oxide and a gaseous magnesium.

In example embodiments, the preliminary silicon composite oxide may be pulverized (e.g., in an operation S30).

In some embodiments, the preliminary silicon composite oxide may be pulverized through a high-pressure pulverizing device such as an air jet mill. For example, the preliminary silicon composite oxide may be put into an air jet mill and pulverized through a vibration caused by a pressure fluctuation due to high turbulence of high-speed air and high frequency.

In example embodiments, a carbon coating layer may be formed on a surface of the preliminary silicon composite oxide using a carbon source to form the silicon composite oxide for an anode active material (e.g., in an operation S40).

In example embodiments, the carbon coating layer may be formed through a thermal decomposition of the carbon source. A temperature of the thermal decomposition of the carbon source may be in a range from 500° C. to 700° C.

When silicon of the silicon composite oxide is exposed to a high temperature, a partial non-uniform reaction may occur. For example, silicon dioxide and silicon may be partially separated from the silicon composite oxide at a high temperature. Accordingly, when the carbon coating layer of the preliminary silicon composite oxide is formed at a high temperature, an electrical conductivity of the silicon composite oxide may be decreased.

However, according to embodiments of the present disclosure, carbon may be coated on the surface of the preliminary silicon composite oxide at a relatively low temperature using a carbon source having a thermal decomposition temperature of 700° C. or less. Accordingly, the carbon coating layer may be formed on the surface of the preliminary silicon composite oxide while suppressing the partial non-uniform reaction of the preliminary silicon composite oxide.

Thus, irregularities or curvatures of the silicon composite oxide may be reduced, and an excessive increase in the BET specific surface area of the silicon composite oxide may be prevented.

For example, when the thermal decomposition temperature of the carbon source is less than 500° C., a formation rate of the carbon coating layer on the preliminary silicon composite oxide may be lowered. Accordingly, the carbon coating layer of the silicon composite oxide may be formed non-uniformly, and the specific surface area may be excessively reduced.

Therefore, the BET specific surface area of the silicon composite oxide may be appropriately maintained (e.g., in a range from 2.0 m²/g to 6.5 m²/g) using the carbon source having the thermal decomposition temperature in the above range.

In some embodiments, the carbon source may have the thermal decomposition temperature in a range from 500° C. to 600° C., greater than or equal to 500° C. and less than 600° C., or from 500° C. to 580° C. Accordingly, the silicon composite oxide with the carbon coating layer having the BET specific surface area in the above-mentioned range may be formed while preventing unevenness of the silicon composite oxide.

In some embodiments, the carbon source may include ethylene or acetylene. A temperature of the thermal decomposition of ethylene or acetylene may be within the above-described range. Thus, carbon may be uniformly coated on the preliminary silicon composite oxide, non-uniformity of the silicon composite oxide may be prevented, and the silicon composite oxide having the BET specific surface area in the above-mentioned range may be formed.

In one embodiment, the carbon source may be ethylene. In this case, carbon can be more uniformly coated on the preliminary silicon composite oxide.

For example, the carbon coating layer may be formed by a chemical vapor deposition (CVD) process.

In some embodiments, the carbon coating layer may be formed by the CVD process at a temperature in a range from 500° C. to 1,000° C., from 500° C. to 900° C., from 500° C. to 800° C., or from 500° C. to 700° C. In the above temperature range, the above-described carbon source may be thermally decomposed and the CVD process may proceed, and the electrical conductivity of the silicon composite oxide may be improved by preventing the non-uniformity of the preliminary silicon composite oxide. Additionally, when the anode containing the silicon composite oxide is charged, a solid electrolyte interphase (SEI) layer may be stably formed.

Hereinafter, experimental examples are proposed to more concretely describe embodiments of the present disclosure. However, the following examples are only given for illustrating the present disclosure and those skilled in the related art will obviously understand that various alterations and modifications are possible within the scope and spirit of the present disclosure. Such alterations and modifications are duly included in the appended claims.

### EXAMPLES AND COMPARATIVE EXAMPLES

### Example 1

### 1) Preparation of Silicon Composite Oxide

A silicon powder, a silicon dioxide powder and a magnesium powder were introduced into a first reactor maintained at 3,000° C. to 3,300° C., a second reactor maintained at 2,000° C. to 2,300° C. and a third reactor maintained at 1,000° C. to 1,200° C., respectively, and then vaporized independently. A mixed gas was prepared by adding the vaporized silicon, the vaporized silicon dioxide and the vaporized magnesium to a mixing reactor in a weight ratio of 46.1:46.1:7.8.

Specifically, the weight ratio of the vaporized silicon, the vaporized silicon dioxide and the vaporized magnesium was measured using an Inductively Coupled Plasma Emission Spectrometer (ICP-OES, Optima 8300) manufactured from Perkin-Elmer.

The mixed gas was reacted and cooled by a cooling fin maintained at 25° C. to prepare a preliminary silicon composite oxide. The preliminary silicon composite oxide was put into an air jet mill and pulverized.

50 g of the pulverized preliminary silicon composite oxide was introduced into a reactor maintained at 900° C. to 1,200° C., and maintained for 1 hour while injecting an Ar gas and a carbon coating source at 1 L/min. Accordingly, a carbon coating layer was formed on a surface of the pulverized preliminary silicon composite oxide to a prepare silicon composite oxide. Ethylene was used as the carbon coating source.

A BET specific surface area of the silicon composite oxide was 2.9 m²/g.

Specifically, the BET specific surface area was measured by an apparatus ASAP2420 (Micromeritics) using nitrogen as a adsorption gas and helium as a carrier gas, and using a 5 pre-defined points-method of a BET relative pressure by a continuous flow.

### 2) Preparation of Anode

5 wt % of the silicon composite oxide as a first anode active material, 91.05 wt % of artificial graphite, 0.25 wt % of SWCNT as a anode conductive material, 2.4 wt % of styrene-butadiene rubber (SBR) as a binder, and 1.3 wt % of carboxymethyl cellulose (CMC) as a thickener were added to a pure water (deionized water) and mixed to obtain a first anode slurry.

23 wt % of the silicon composite oxide as the second anode active material, 74.85 wt % of artificial graphite, 0.25 wt % of SWCNT as the anode conductive material, 0.6 wt % of styrene-butadiene rubber (SBR) as a binder, and 1.3 wt % of carboxymethyl cellulose (CMC) as a thickener were added to a pure water (deionized water) and mixed to obtain a second anode slurry.

The first anode slurry and the second anode slurry were coated on a Cu foil current collector, dried and pressed to form a first anode active material layer and a second anode active material layer.

Specifically, the first anode slurry was coated on the Cu foil current collector, and the second cathode slurry was coated on the first cathode slurry. Thereafter, the first anode slurry and the second anode slurry above were dried together to form the first anode active material layer and the second anode active material layer.

### 3) Fabrication of Cathode and Secondary Battery.

A cathode slurry was prepared by mixing LiNi_{0.8}Co_{0.1}Mn_{0.1}O₂ as a cathode active material, a mixture of carbon black and carbon nanotube (CNT) as a cathode conductive material, and polyvinylidene fluoride (PVDF) as a cathode binder in distilled water in a weight ratio of 98.3:0.7:1. The cathode slurry was coated on an Al foil current collector, dried and roll pressed to prepare a cathode.

A separator (polyethylene, thickness: 13 μm) was interposed between the cathode and anode to form a battery, and tab portions of the cathode and tab portions of the anode were welded.

The welded anode/separator/cathode assembly was put in a pouch, and sealing sides excluding an electrolyte injection side were sealed so that the tab portions was included in the sealing portion. Thereafter, the electrolyte solution was injected through the electrolyte injection side, the electrolyte injection side was also sealed, and then impregnation was performed for 12 hours to manufacture a secondary battery.

In a preparation of the electrolyte solution, 5 wt % of fluorinated ethylene carbonate (FEC), 0.5 wt % of propane sultone (PS), and 0.5 wt % of ethylene sulfate (ESA) were added to a 1 M LiPF₆ solution using a mixed solvent of EC/EMC (25/75; volume ratio).

### Preparation of Carbon-Coated Silicon Oxide

A silicon powder and a silicon dioxide powder were each introduced into a first reactor maintained at 3,000° C. to 3,300° C. and a second reactor maintained at 2,000° C. to 2,300° C. to be independently vaporized. The vaporized silicon and the vaporized silicon dioxide were introduced into a mixing reactor in a weight ratio of 1:1 to form a mixed gas.

The mixed gas was reacted, and a preliminary silicon oxide was prepared by cooling with a cooling fin maintained at 25° C. The preliminary silicon oxide was put into an air jet mill and pulverized.

50 g of the pulverized preliminary silicon oxide was placed in a reactor at 900° C. to 1,200° C., and maintained for 1 hour while injecting an Ar gas and a carbon coating source at 1 L/min to deposit carbon on a surface of the pulverized preliminary silicon oxide. Thus, a coating layer was formed to prepare a carbon-coated silicon oxide. Ethylene was used as the carbon coating source.

### Examples 2 to 8 and Comparative Examples 1 to 8

In the preparation of the silicon composite oxide (C—Mg—SiOx) or the carbon-coated silicon oxide (C—SiOx), the carbon coating source, the type and content of the active material included in the first anode active material layer, and the type and content of the active material included in the second anode active material layer were adjusted as shown in Table 1 below.

Examples 2 to 8 and Comparative Examples 1 to 8 were prepared by the same method as that in Example 1 except that the weight ratio of the vaporized silicon, the vaporized silicon dioxide and the vaporized magnesium introduced into the mixing reactor, and specific surface areas of the silicon composite oxide or the carbon-coated silicon oxide were adjusted as shown in Table 2 below in the preparation of the silicon composite oxide,

TABLE 1

| | active material type | | | | |
|---|---|---|---|---|---|
| | carbon coating | | | | |
| | source of | | | | |
| | C—Mg—SiOₓ | first anode active material | | second anode active material | |
| | or | | content | | content |
| | C—SiOₓ | type | (wt %) | type | (wt %) |
| Example 1 | ethylene | C—Mg—SiOₓ | 5 | C—Mg—SiOₓ | 23 |
| | | C—SiOₓ | — | C—SiOₓ | — |
| | | artificial | 91.05 | artificial | 74.85 |
| | | graphite | | graphite | |
| Example 2 | acetylene | C—Mg—SiOₓ | 5 | C—Mg—SiOₓ | 23 |
| | | C—SiOₓ | — | C—SiOₓ | — |
| | | artificial | 91.05 | artificial | 74.85 |
| | | graphite | | graphite | |
| Example 3 | ethylene | C—Mg—SiOₓ | 3 | C—Mg—SiOₓ | 23 |
| | | C—SiOₓ | — | C—SiOₓ | — |
| | | artificial | 93.05 | artificial | 74.85 |
| | | graphite | | graphite | |
| Example 4 | ethylene | C—Mg—SiOₓ | 8 | C—Mg—SiOₓ | 23 |
| | | C—SiOₓ | — | C—SiOₓ | — |
| | | artificial | 88.05 | artificial | 74.85 |
| | | graphite | | graphite | |
| Example 5 | ethylene | C—Mg—SiOₓ | 5 | C—Mg—SiOₓ | 19 |
| | | C—SiOₓ | — | C—SiOₓ | — |
| | | artificial | 91.05 | artificial | 78.85 |
| | | graphite | | graphite | |
| Example 6 | ethylene | C—Mg—SiOₓ | 5 | C—Mg—SiOₓ | 28 |
| | | C—SiOₓ | — | C—SiOₓ | — |
| | | artificial | 91.05 | artificial | 69.85 |
| | | graphite | | graphite | |
| Example 7 | ethylene | C—Mg—SiOₓ | 5 | C—Mg—SiOₓ | 23 |
| | | C—SiOₓ | — | C—SiOₓ | — |
| | | artificial | 91.05 | artificial | 74.85 |
| | | graphite | | graphite | |
| Example 8 | ethylene | C—Mg—SiOₓ | 5 | C—Mg—SiOₓ | 23 |
| | | C—SiOₓ | — | C—SiOₓ | — |
| | | artificial | 91.05 | artificial | 74.85 |
| | | graphite | | graphite | |
| Comparative | ethylene | C—Mg—SiOₓ | — | C—Mg—SiOₓ | — |
| Example 1 | | C—SiOₓ | 4 | C—SiOₓ | 23 |
| | | artificial | 92.05 | artificial | 74.85 |
| | | graphite | | graphite | |
| Comparative | ethylene | C—Mg—SiOₓ | — | C—Mg—SiOₓ | — |
| Example 2 | | C—SiOₓ | 4 | C—SiOₓ | 19 |
| | | artificial | 92.05 | artificial | 78.85 |
| | | graphite | | graphite | |
| Comparative | acetylene | C—Mg—SiOₓ | — | C—Mg—SiOₓ | — |
| Example 3 | | C—SiOₓ | 4 | C—SiOₓ | 23 |
| | | artificial | 92.05 | artificial | 74.85 |
| | | graphite | | graphite | |
| Comparative | methane | C—Mg—SiOₓ | — | C—Mg—SiOₓ | — |
| Example 4 | | C—SiOₓ | 4 | C—SiOₓ | 23 |
| | | artificial | 92.05 | artificial | 74.85 |
| | | graphite | | graphite | |
| Comparative | ethylene | C—Mg—SiOₓ | 5 | C—Mg—SiOₓ | 23 |
| Example 5 | | C—SiOₓ | — | C—SiOₓ | — |
| | | artificial | 91.05 | artificial | 74.85 |
| | | graphite | | graphite | |
| Comparative | ethylene | C—Mg—SiOₓ | 5 | C—Mg—SiOₓ | 23 |
| Example 6 | | C—SiOₓ | — | C—SiOₓ | — |
| | | artificial | 91.05 | artificial | 74.85 |
| | | graphite | | graphite | |
| Comparative | methane | C—Mg—SiOₓ | 5 | C—Mg—SiOₓ | 23 |
| Example 7 | | C—SiOₓ | — | C—SiOₓ | — |
| | | artificial | 91.05 | artificial | 74.85 |
| | | graphite | | graphite | |
| Comparative | methane | C—Mg—SiOₓ | 3 | C—Mg—SiOₓ | 19 |
| Example 8 | | C—SiOₓ | — | C—SiOₓ | — |
| | | artificial | 93.05 | artificial | 78.85 |
| | | graphite | | graphite | |

TABLE 2

| | weight ratio of vaporized silicon, vaporized silicon | BET specific surface area | |
|---|---|---|---|
| | dioxide and vaporized magnesium | (m²/g) | |
| Example 1 | 46.1:46.1:7.8 | C—Mg—SiOₓ | 2.9 |
| | | C—SiOₓ | — |
| Example 2 | 46.05:46.05:7.9 | C—Mg—SiOₓ | 5.9 |
| | | C—SiOₓ | — |
| Example 3 | 46.1:46.1:7.8 | C—Mg—SiOₓ | 2.9 |
| | | C—SiOₓ | — |
| Example 4 | 46.1:46.1:7.8 | C—Mg—SiOₓ | 2.9 |
| | | C—SiOₓ | — |
| Example 5 | 46.1:46.1:7.8 | C—Mg—SiOₓ | 2.9 |
| | | C—SiOₓ | — |
| Example 6 | 46.1:46.1:7.8 | C—Mg—SiOₓ | 2.9 |
| | | C—SiOₓ | — |
| Example 7 | 48:48:4 | C—Mg—SiOₓ | 6.5 |
| | | C—SiOₓ | — |
| Example 8 | 44.9:44.9:10.2 | C—Mg—SiOₓ | 2.2 |
| | | C—SiOₓ | — |
| Comparative | — | C—Mg—SiOₓ | — |
| Example 1 | | C—SiOₓ | 4 |
| Comparative | — | C—Mg—SiOₓ | — |
| Example 2 | | C—SiOₓ | 5.6 |
| Comparative | — | C—Mg—SiOₓ | — |
| Example 3 | | C—SiOₓ | 6.4 |
| Comparative | — | C—Mg—SiOₓ | — |
| Example 4 | | C—SiOₓ | 6.22 |
| Comparative | 49:49:2 | C—Mg—SiOₓ | 7.2 |
| Example 5 | | C—SiOₓ | — |
| Comparative | 43:43:14 | C—Mg—SiOₓ | 1.8 |
| Example 6 | | C—SiOₓ | — |
| Comparative | 46.25:46.25:7.5 | C—Mg—SiOₓ | 6.7 |
| Example 7 | | C—SiOₓ | — |
| Comparative | 45.75:45.75:8.5 | C—Mg—SiOₓ | 6.7 |
| Example 8 | | C—SiOₓ | — |

### Experiment Example

### (1) XRD Analysis—Crystallite Size Measurement in (220) Plane of C—Mg—SiOx

For Examples and Comparative Examples, crystallite sizes in a (220) plane of the C—Mg—SiOx (silicon composite oxide) was calculated using an XRD diffraction analysis and Equation 1 below.

$${L}_{220} = \frac{K λ}{{β}_{220} cos θ} \qquad [ Equation 1 ]$$

In Equation 1, L₂₂₀ represents the crystallite size (nm) in the (220) plane, K represents a shape factor(0.8), λ represents an X-ray wavelength (nm), β₂₂₀ represents a full width at half maximum (rad) of a peak of the (220) plane through an XRD analysis, and θ represents a diffraction angle (rad).

Specific XRD analysis equipment/conditions are shown in Table 3 below.

TABLE 3
XRD (X-Ray Diffractometer, EMPYREAN)

| Maker | PANalytical | |
|---|---|---|
| Anode material | Cu | |
| K-Alpha1 wavelength | 1.540598 | Å |
| Generator voltage | 45 | kV |
| Tube current | 40 | mA |

| | |
|---|---|
| Scan Range | 10~120° |
| Scan Step Size | 0.0065° |
| Divergence slit | ¼° |
| Antiscatter slit | 1° |

### (2) Evaluation on Initial Capacity Efficiency Evaluation

The lithium secondary batteries manufactured according to Examples and Comparative Examples were charged (CC-CV 1/3C 4.2V 0.05C CUT-OFF) in a 25° C. chamber and a battery capacity (initial charge capacity) was measured. The batteries were discharged (CC 1/3C 2.5V CUT-OFF) again, and a battery capacity (initial discharge capacity) was measured.

An initial capacity efficiency was evaluated by a percentage (%) of the measured initial discharge capacity relative to the measured initial charge capacity.

### (3) Room Temperature Life-Span (Cycle) Property

The lithium secondary batteries manufactured according to Examples and Comparative Examples were charged at room temperature (25° C.) under 1/3C 4.2V and 0.05C CUT-OFF conditions and left for 10 minutes, and discharged under 0.5C and 2.5V CUT-OFF conditions and left for 10 minutes. Thereafter, 800 cycles of the charge/discharge were performed for 10 minutes.

A room temperature life-span property was evaluated by calculating a ratio of the discharge capacity measured after performing 800 cycles of the charge/discharge to the discharge capacity measured after performing a single charge/discharge cycle as a percentage.

The evaluation results are shown in Table 4 below.

TABLE 4

| | crystallite size of | room temperature | initial capacity |
|---|---|---|---|
| | C—Mg—SiOₓ (nm) | life-span property (%) | efficiency (%) |
| Example 1 | 7.0 | 94 | 82.7 |
| Example 2 | 6.0 | 91 | 81.2 |
| Example 3 | 7.0 | 92 | 82.6 |
| Example 4 | 7.0 | 93 | 81.9 |
| Example 5 | 7.0 | 90 | 82.4 |
| Example 6 | 7.0 | 92 | 81.2 |
| Example 7 | 4.6 | 90 | 82.9 |
| Example 8 | 8.3 | 91 | 81.0 |
| Comparative | — | 87 | 75.6 |
| Example 1 | | | |
| Comparative | — | 85 | 75.0 |
| Example 2 | | | |
| Comparative | — | 86 | 75.3 |
| Example 3 | | | |
| Comparative | — | 89 | 75.2 |
| Example 4 | | | |
| Comparative | 3.3 | 89 | 79.4 |
| Example 5 | | | |
| Comparative | 10.1 | 88 | 77.7 |
| Example 6 | | | |
| Comparative | 6.7 | 91 | 78.3 |
| Example 7 | | | |
| Comparative | 8.5 | 89 | 79.2 |
| Example 8 | | | |

Referring to Table 4, in Examples where ethylene or acetylene was used as the carbon source, the carbon-coated silicon composite oxide was used as the active material and the BET specific surface area was in a range from 2.0 m²/g to 6.5 m²/g, the initial capacity efficiency was 81% or more.

In Example 2 where acetylene was used as the carbon source and the carbon-coated silicon composite oxide was used as the active material, the room temperature life-span property and the initial capacity efficiency were slightly decreased.

In Examples 3 and 5 where the content of the silicon composite oxide active material was reduced, the initial capacity efficiency was slightly reduced.

In Examples 4 and 6 where the content of the silicon composite oxide active material was increased, the initial capacity efficiency was slightly decreased.

In Example 7 where the BET specific surface area of the silicon composite oxide was increased but the crystallite size and the magnesium weight of the silicon composite oxide were reduced, the initial capacity efficiency was increased but the room temperature life-span property was slightly decreased.

In Example 8 where the BET specific surface area of the silicon composite oxide was reduced but the crystallite size and the magnesium weight of the silicon composite oxide were increased, the room temperature life-span property and the initial capacity efficiency were slightly decreased.

In Comparative Examples using the carbon-coated silicon oxide devoid of magnesium as the active material, the room temperature lifespan property and the initial capacity efficiency were degraded.

In Comparative Example 5 where the BET specific surface area exceeded 6.5 m²/g and the crystallite size of the silicon composite oxide was reduced, the room temperature life-span property and the initial capacity efficiency were degraded.

In Comparative Example 6 where the BET specific surface area was less than 2.0 m²/g and the crystallite size of the silicon composite oxide was increased, the room temperature life-span property and the initial capacity efficiency were degraded.

In Comparative Example 7 using methane as the carbon source and the carbon-coated silicon composite oxide as the active material, the initial capacity efficiency was decreased.

In Comparative Example 8 using methane as the carbon source and the carbon-coated silicon composite oxide as the active material and the crystallite size of the silicon composite oxide was increased, the room temperature life-span property and the initial capacity efficiency were degraded.

What is claimed is:

1. An anode for a secondary battery, comprising:
an anode current collector;
a first anode active material layer disposed on at least one surface of the anode current collector, the first anode active material layer including a first anode active material that includes a first silicon composite oxide; and
a second anode active material layer disposed on the first anode active material layer, the second anode active material layer including a second anode active material that includes a second silicon composite oxide,
wherein each of the first silicon composite oxide and the second silicon composite oxide includes a metal, and
a BET specific surface area of each of the first silicon composite oxide and the second silicon composite oxide is in a range from 2.0 m²/g to 6.5 m²/g.

2. The anode for a secondary battery according to claim 1, wherein the metal includes magnesium.

3. The anode for a secondary battery according to claim 2, wherein each of the first silicon composite oxide and the second silicon composite oxide includes SiOx (0<x<2) doped with magnesium and a carbon coating layer formed on a surface thereof.

4. The anode for a secondary battery according to claim 2, wherein each of the first silicon composite oxide and the second silicon composite oxide includes 5.0 wt % to 10.0 wt % of magnesium.

5. The anode for a secondary battery according to claim 1, wherein a sum of weights of the first silicon composite oxide and the second silicon composite oxide is 10 wt % to 20 wt % of a total weight of the first anode active material layer and the second anode active material layer.

6. The anode for a secondary battery according to claim 5, wherein a weight-based content of the first silicon composite oxide included in the first anode active material layer is less than a weight-based content of the second silicon composite oxide included in the second anode active material layer.

7. The anode for a secondary battery according to claim 6, wherein the content of the first silicon composite oxide is in a range from 2 wt % to 10 wt % based on a total weight of the first anode active material layer.

8. The anode for a secondary battery according to claim 6, wherein the content of the second silicon composite oxide is in a range from 18 wt % to 30 wt % based on a total weight of the second anode active material layer.

9. The anode for a secondary battery according to claim 1, wherein each crystallite size in a (220) plane defined by Equation 1 of the first silicon composite oxide and the second silicon composite oxide is in a range from 3.5 nm to 10 nm:
$${L}_{220} = \frac{K λ}{{β}_{220} cos θ} \qquad [ Equation 1 ]$$
In Equation 1, L₂₂₀ represents the crystallite size (nm) in the (220) plane, K represents a shape factor, λ represents an X-ray wavelength (nm), β₂₂₀ represents a full width at half maximum (rad) of a peak of the (220) plane through an XRD analysis, and θ represents a diffraction angle (rad).

10. The anode for a secondary battery according to claim 1, wherein the BET specific surface area of each of the first silicon composite oxide and the second silicon composite oxide is in a range from 2.5 m²/g to 6.0 m²/g.

11. A lithium secondary battery, comprising:
the anode for a secondary battery according to claim 1; and
a cathode facing the anode.

12. A method of preparing a silicon composite oxide for an anode active material, comprising:
reacting a mixed gas of silicon (Si), silicon dioxide (SiO₂) and a metal to form a preliminary silicon composite oxide; and
forming a carbon coating layer on a surface of the preliminary silicon composite oxide using a carbon source that has a thermal decomposition temperature of 500° C. to 700° C.

13. The method of claim 12, wherein the metal includes magnesium.

14. The method of claim 12, wherein the carbon source includes at least one of ethylene and acetylene.
